(19) United States
(12) Patent Application Publication
(10) Pub. No.: US 2024/0031635 A1
(43) Pub. Date: Jan. 25, 2024

(54) AUDIO-VISUAL DATA MANAGING SYSTEM, AUDIO-VISUAL DATA MANAGING METHOD

(71) Applicant: Realtek Semiconductor Corp., HsinChu (TW)

(72) Inventor: Chien-Chang Chen, HsinChu (TW)

(73) Assignee: Realtek Semiconductor Corp., HsinChu (TW)

(21) Appl. No.: 18/225,163

(22) Filed: Jul. 24, 2023

(30) Foreign Application Priority Data
Jul. 25, 2022 (TW) 111127778

(51) Int. Cl. H04N 21/426; H04N 21/438

(52) U.S. Cl. CPC H04N 21/42607; H04N 21/438

(57) ABSTRACT

An audio-visual managing system, applied to at least one data receiving circuit which receives audio-visual data and outputs processed audio-visual data, each of the data receiving circuit comprising a tuner or a demodulator, the audio-visual managing system comprising: a plurality of transmitting circuits, configured to stream the processed audio-visual data; wherein the processed audio-visual data output by a first data receiving circuit of the data receiving circuit can be used by a first transmitting circuit and a second transmitting circuit of the transmitting circuits simultaneously, when the first transmitting circuit and the second transmitting circuit receive the processed audio-visual data output by the first data receiving circuit.

### BACKGROUND OF THE INVENTION

### 1. Field of the Invention

The present invention relates to An audio-visual data managing system, an audio-visual data managing method, and particularly relates to An audio-visual data managing system, an audio-visual data managing method which do not link to play software and hardware.

### 2. Description of the Prior Art

Users often needs to switch channels when watching cable TV. However, in a conventional TV, play software (or called a player) is often linked to the hardware in the TV. That is to say, the hardware in the TV is controlled and used exclusively by the play software, and the control right of the hardware is not released until the user ends using the play software (for example, turning off the TV or stopping play). Therefore, when the user switches TV channels, the TV must stop the play software from controlling the hardware in the TV, and the hardware in the TV must be reconnected with the data source (such as the server room of the cable TV provider). Under such mechanism, the user needs to wait for a long time when switching between different TV channels. In addition, due to such mechanism, if the same data source is to be sent to multiple play software at the same time, multiple sets of hardware are required for streaming. However, not every TV has multiple sets of hardware.

Moreover, if the user switches the TV to a different data source, it is often necessary to switch to a different control interface for control, which causes inconvenience for the user.

### SUMMARY OF THE INVENTION

One objective of the present invention is to provide an audio visual data managing system and an audio visual data managing method which can share a data receiving circuit.

Another objective of the present invention is to provide an audio visual data managing system which can predicts and accordingly pre-connect a data source of the audio visual data.

One embodiment of the present invention discloses an audio-visual managing system, applied to at least one data receiving circuit which receives audio-visual data and outputs processed audio-visual data, each of the data receiving circuit comprising a tuner or a demodulator, the audio-visual managing system comprising: a plurality of transmitting circuits, configured to stream the processed audio-visual data; wherein the processed audio-visual data output by a first data receiving circuit of the data receiving circuit can be used by a first transmitting circuit and a second transmitting circuit of the transmitting circuits simultaneously, when the first transmitting circuit and the second transmitting circuit receive the processed audio-visual data output by the first data receiving circuit.

Another embodiment of the present invention discloses an audio-visual managing system, applied to at least one data receiving circuit which receives audio-visual data and outputs processed audio-visual data, each of the data receiving circuit comprising a tuner or a demodulator, the audio-visual managing system comprising: a plurality of transmitting circuits, configured to stream the processed audio-visual data, a first transmitting circuit of the transmitting circuits receiving the processed audio-visual data output by a first data receiving circuit of the data receiving circuits; and an predicting circuit, configured to pre-connect a second transmitting circuit of the transmitting circuits to one of the data receiving circuits according to predicting information which is recorded.

Still another embodiment of the present invention discloses an audio-visual managing method, applied to at least one data receiving circuit which receives audio-visual data and outputs processed audio-visual data, each of the data receiving circuit comprising a tuner or a demodulator, the audio-visual managing method comprising: receiving the processed audio-visual data output by a first data receiving circuit by a first transmitting circuit and a second transmitting circuit of the transmitting circuits; and simultaneously using the processed audio-visual data which is output by the first data receiving circuit, via the first transmitting circuit and the second transmitting circuit.

According to the above-mentioned embodiments, different transmitting circuits can share the same data receiving circuit, and the play software does not take exclusive control of the hardware. Further, with the predicting mechanism, users can quickly switch between different TV channels or different data sources.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, FIG. 2, FIG. 3 and FIG. 4 are block diagrams illustrating audio-visual data managing systems according to different embodiments of the present invention.

FIG. 5 is a flow chart illustrating an audio-visual data managing method according to one embodiment of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

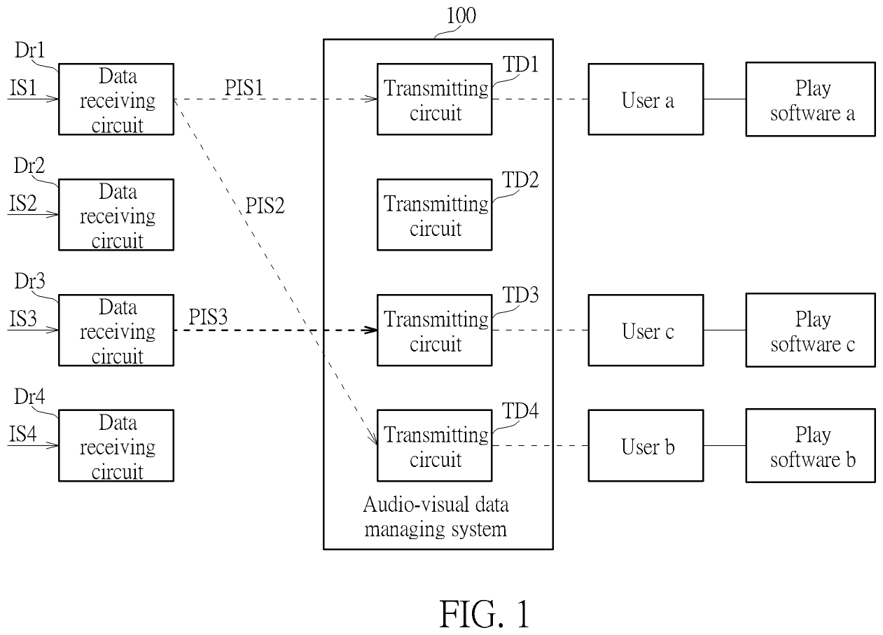

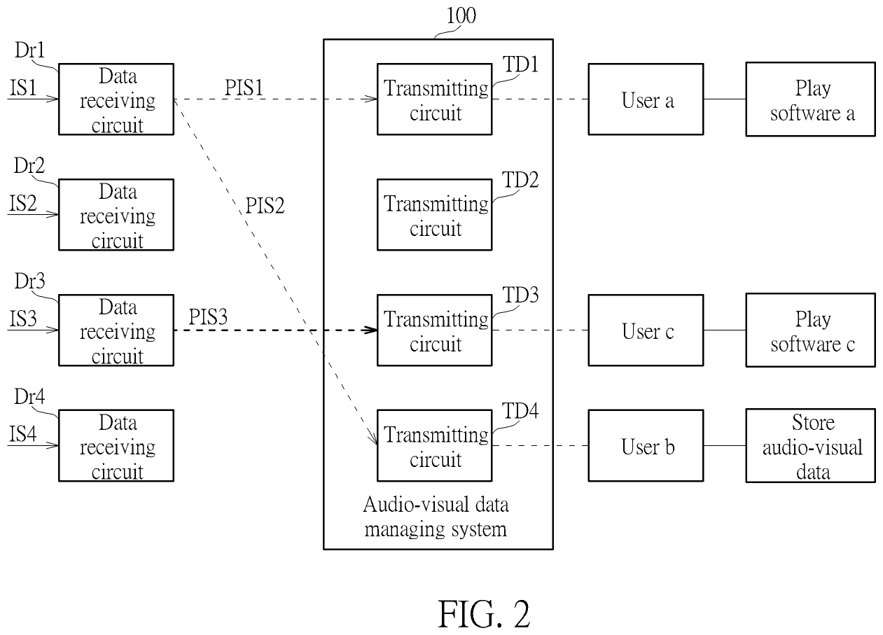

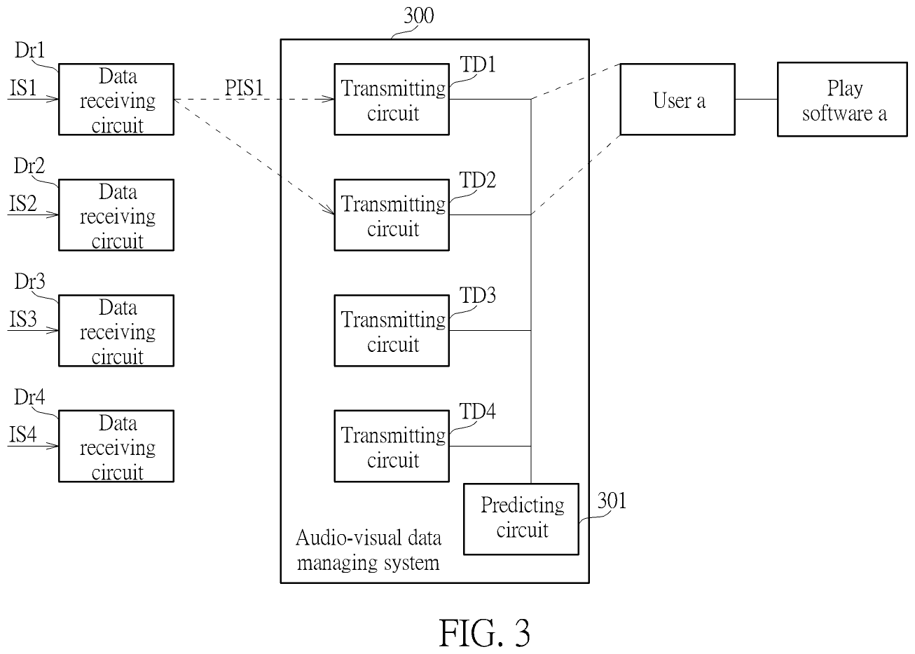

FIG. 1, FIG. 2, FIG. 3 and FIG. 4 are block diagrams illustrating audio-visual data managing systems according to different embodiments of the present invention. As shown in FIG. 1, the audio-visual data managing system 100 is used for at least one data receiving circuit Dr1, Dr2, Dr3, Dr4 (four in this example), comprising a plurality of transmitting circuits TD1, TD2, TD3, TD4. The transmitting circuit may also be referred to as a transport module. Each of the data receiving circuits Dr1, Dr2, Dr3, and Dr4 comprises a tuner or a demodulator, and can receive audio-visual data and process the audio-visual data with the tuner or the demodulator to generate processed audio-visual data. The audio-visual data IS1, IS2, IS3 and IS4 can be various types of audio-visual data, for example, the audio-visual data IS1, IS2, IS3 and IS4 can be cable TV data, Internet Protocol Television (IPTV) or personal video files, but not limited to these audio-visual data. In one embodiment, the audio and audio-visual data IS1, IS2, IS3 and IS4 may be data streams.

The transmitting circuits TD1, TD2, TD3, and TD4 are used to stream the processed audio-visual data. For example, the transmitting circuits TD1, TD2, TD3, and TD4 can stream the processed audio-visual data into video data and audio data. In one embodiment, if the processed audio-visual data is TV data, it may comprise program information. In this case, the transmitting circuits TD1, TD2, TD3, and TD4 can also stream the program information of the processed audio-visual data. The streamed data can be sent to other circuits such as a decoder for subsequent processing. In the embodiment of FIG. 1, if a first transmitting circuit and a second transmitting circuit (that is, two different transmitting circuits) in the transmitting circuit receive the processed audio-visual data output by a first data receiving circuit (that is, the same data receiving circuit) of the data receiving circuits, the processed audio-visual data output by the first data receiving circuit can be simultaneously used by the first transmitting circuit and the second transmitting circuit at the same time. In one embodiment, the user can use different play programs to play the audio-visual data generated by the first transmitting circuit and the second transmitting circuit and according to the processed audio-visual data output by the first data receiving circuit.

For example, in the embodiment of FIG. 1, the processed audio-visual data PIS1 output by the data receiving circuit Dr1 is received by the transmitting circuit TD1 and the transmitting circuit TD4, and then the transmitting circuit TD1 and the transmitting circuit TD4 respectively stream the processed audio-visual data PIS1. The streamed processed audio-visual data PIS1 is sent to subsequent circuits (e.g., a decoder or a graphic engine) to generate playable audio-visual data. A user a can use play software a (or named a play program a) to play the audio-visual data, while user b uses play software b to play the audio-visual data at the same time. The play software a and the play software b here can be play software having different program contents, or can be play software having the same program contents but independent of each other thus can be used by different users at the same time. In the embodiment of FIG. 1, the processed audio-visual data PIS3 output by the data receiving circuit Dr3 is only received by one transmitting circuit TD3 instead of two transmitting circuits. The user c can use the play software c to play audio-visual data generated via the transmitting circuit TD3 and according to the processed audio-visual data PIS3.

In another embodiment, the audio-visual data generated by the first transmitting circuit and according to the processed audio-visual data output by the first data receiving circuit is played, while the audio-visual data generated by the second transmitting circuit and according to the processed audio-visual data output by the first data receiving circuit is stored.

For example, in the embodiment of FIG. 2, the processed audio-visual data PIS1 output by the data receiving circuit Dr1 is received by the transmitting circuit TD1 and the transmitting circuit TD4, and then the transmitting circuit TD1 and the transmitting circuit TD4 respectively stream the processed audio-visual data PIS1. The streamed processed audio-visual data PIS1 is sent to subsequent circuits to generate playable audio-visual data. The user a can use the play software a to play the audio-visual data generated by the transmitting circuit TD1 and the processed audio-visual data PIS1, and the audio-visual data generated by the transmitting circuit TD4 and according to the processed audio-visual data PIS1 can also be stored at the same time. In the embodiment of FIG. 2, the processed audio-visual data PIS3 output by the data receiving circuit Dr2 is only received by one transmitting circuit TD3 instead of two transmitting circuits. User c can use play software c to play the audio-visual data.

Compared with the prior art, the data receiving circuit Dr1 can be shared by two transmitting circuits and is not exclusively used by a single play software, which can improve the problem of the audio-visual data managing system in the prior art. In one embodiment, the audio-visual data managing system 100 can be implemented by a chip, so it can be externally connected to an electronic circuit having one or more data receiving circuits, and has a better application range.

In another embodiment, the audio-visual data managing system provided by the present invention provides a predicting mechanism for pre-connecting the transmitting circuit and another data receiving circuit when a transmitting circuit and a data receiving circuit operate, to allow users to switch quickly. In the following embodiments, the cable TV is used for illustration, but the following embodiments can also be applied to other data sources.

As shown in FIG. 3, the audio-visual data managing system 300 is used for at least one data receiving circuit Dr1, Dr2, Dr3, Dr4 (four in this example), comprising a plurality of transmitting circuits TD1, TD2, TD3, TD4. Similar to the embodiment in FIG. 1, the data receiving circuits Dr1, Dr2, Dr3, and Dr4 are used to respectively receive the audio-visual data IS1, IS2, IS3 and IS4 and output the processed audio-visual data. The data receiving circuits Dr1, Dr2, Dr3, Dr4 can receive the audio-visual data and process the audio-visual data with a tuner or a demodulator to generate the processed audio-visual data. The audio-visual data IS1, IS2, IS3 and IS4 can be various types of audio-visual data, for example, the audio-visual data IS1, IS2, IS3 and IS4 can be cable TV data, IPTV data or personal video files, but not limited to these audio-visual data.

The transmitting circuits TD1, TD2, TD3, and TD4 are used to stream the processed audio-visual data. For example, the transmitting circuits TD1, TD2, TD3, and TD4 steam the processed audio-visual data into video data and audio data. In one embodiment, if the processed audio-visual data is TV data, it may comprise program information. In this case, the transmitting circuits TD1, TD2, TD3, and TD4 can also stream the program information of the processed audio-visual data. The streamed data can be sent to other circuits such as a decoder for subsequent processing. In the embodiment shown in FIG. 3, the transmitting circuit TD1 (the first transmitting circuit) receives the processed audio-visual data PIS1 output by the data receiving circuit Dr1 (the first data receiving circuit), and the user a uses the play software a to watch the audio-visual which is generated by the transmitting circuit TD1 and according to the processed audio-visual data PIS1. For example, the audio-visual data IS1 is cable TV data, and the user a uses the play software a to watch the TV channel A.

In the embodiment of FIG. 3, the audio-visual data managing system 300 further comprises a predicting circuit 301. The predicting circuit 301 pre-connects the second transmitting circuit of the transmitting circuits and one of the data receiving circuits according to the recorded predicting information. For example, the predicting circuit 301 pre-connects the data receiving circuit Dr1 and the transmitting circuit TD2 according to the recorded predicting information, so that the user can quickly switch from the transmitting circuit TD1 to the transmitting circuit TD2. If the transmitting circuit TD2 corresponds to the TV channel B, it means that the user a can quickly switch from the TV channel A corresponding to the transmitting circuit TD1 to the TV channel B. In addition, the predicting circuit provided by the present invention can use different algorithms according to different requirements. For example, different algorithms can be used for different data sources. When the data receiving circuit is used to receive IPTV data, an algorithm corresponding to IPTV can be used. When the data receiving circuit receives satellite TV data, an algorithm corresponding to the satellite TV data can be used.

The pre-connection here can also be referred to as pre-loading, that is, allowing the transmitting circuit to perform the required connection processing with the data source that provides required data to the data receiving circuit, such as linking, synchronization, frequency locking, noise reduction, pre-loading audio-visual data and program information. Therefore, when the user switches to a different transmitting circuit, he can immediately watch the audio-visual data corresponding to the transmitting circuit without performing connection processing again as in the prior art. Please note, the steps required for pre-connection may vary for different data sources.

The predicting information may comprise various information. In one embodiment, the predicting information comprises time information of different audio-visual data watched in a predetermine time, and the predicting circuit 301 performs pre-connection according to the time information. Such time information can represent a length of time or a number of times. For example, the predicting information comprises the time lengths or times of different TV channels watched within a predetermined time period, and the predicting circuit 301 pre-connects the TV channels with longer watched time lengths or larger watched times. For example, the predicting circuit 301 pre-connects the TV channels which are watched more than 10 hours (time length) in a week or more than 20 times (number of times) in a week. The predicting information can be stored in a storage device, which can be located in the same device as the transmitting circuits TD1, TD2, TD3 and TD4, but can also be an external storage device (such as a memory card or a flash drive) or an on line storage device.

In another embodiment, the predicting information comprises a corresponding relation between the user and watch frequencies of different audio-visual data, and the predicting circuit 301 performs pre-connection according to the corresponding relation. For example, the corresponding relation indicates that user X watches channel 1 and channel 2 more often, while user Y watches channel 3 and channel 4 more often. When the audio-visual data managing system 300 receives the user information representing user X, channels 1 and 2 will be pre-connected. User information can be entered by the user, such as logging into the user's account before watching the audio-visual data or selecting which user is using the e audio-visual data managing system 300.

In addition to pre-connection for the same data receiving circuit, the audio-visual data managing system provided by the present invention can also perform pre-connection for different data receiving circuits. As shown in FIG. 4, the transmitting circuit TD1 (first transmitting circuit) receives the processed audio-visual data PIS1 output by the data receiving circuit Dr1 (the first data receiving circuit), and the user a uses the play software a to watch the audio-visual data generated by the transmitting circuit TD1 and according to the processed audio-visual data PIS1. In the embodiment of FIG. 4, the predicting circuit 301 pre-connects the transmitting circuit TD2 (second transmitting circuit) to the data receiving circuit Dr2 according to the predicting information, instead of the data receiving circuit Dr1 in FIG. 3. The predicting information may comprise the time information or the corresponding relation in the embodiment of FIG. 3. In the embodiment of FIG. 4, the data receiving circuit Dr1 and the data receiving circuit Dr2 can correspond to different audio-visual data. For example, the data receiving circuit Dr1 corresponds to a cable TV and the data receiving circuit Dr2 corresponds to a personal video file. Therefore, in the embodiment of FIG. 4, the user can quickly switch between different data sources.

Please note, in the aforementioned embodiments, the predicting circuit only pre-connects to a set of the transmitting circuit and the data receiving circuit. However, in other embodiments, the predicting circuit may pre-connect more than one sets of transmitting circuits and data receiving circuits. Different sets of transmitting circuits and data receiving circuits may use the same data receiving circuit or different data receiving circuits. For example, as described in the embodiment of FIG. 3, when the user watches the processed audio-visual data output by the data receiving circuit Dr1 through the transmitting circuit TD1, the predicting circuit 301 pre-connects the data receiving circuit Dr1 and the transmitting circuit TD2 according to the recorded predicting information, so that the user can quickly switch from the transmitting circuit TD1 to the transmitting circuit TD2. In such case, if the transmitting circuit TD4 receives the processed audio-visual data output by the data receiving circuit Dr4, when the user watches the processed audio-visual data output by the data receiving circuit Dr1 through the transmitting circuit TD1, the predicting circuit 301 pre-connects the data receiving circuit Dr4 and the transmitting circuit TD4 according to the recorded predicting information, so that the user can quickly switch from the transmitting circuit TD1 to the transmitting circuit TD4.

In a practical application example, if the user's TV has four sets of transmitting circuits and data receiving circuits, and the user uses one set of the transmitting circuit and the data receiving circuit to watch TV programs, the predicting circuit may pre-connect the TV program of the previous channel, the TV program of the next channel, and the TV program of the last watched channel according to the recorded predicting information. Also, if the user uses one set of the transmitting circuit and the data receiving circuit to watch TV programs and uses the other set of the transmitting circuit and the data receiving circuit to record audio-visual data, the predicting circuit can pre-connect the TV programs of the next channel and the last watched channel according to the recorded predicting information. If the user temporarily uses a set of the transmitting circuit and the data receiving circuit for other functions (e.g., recording audio-visual data of a new channel), the predicting circuit cancel one of the pre-connections according to the recorded predicting information. For example, the predicting circuit may cancel the pre-connections for channels that have less watch times or watch frequencies. It will be appreciated that these examples are for illustration only, and are not intended to limit the scope of application of the present invention.

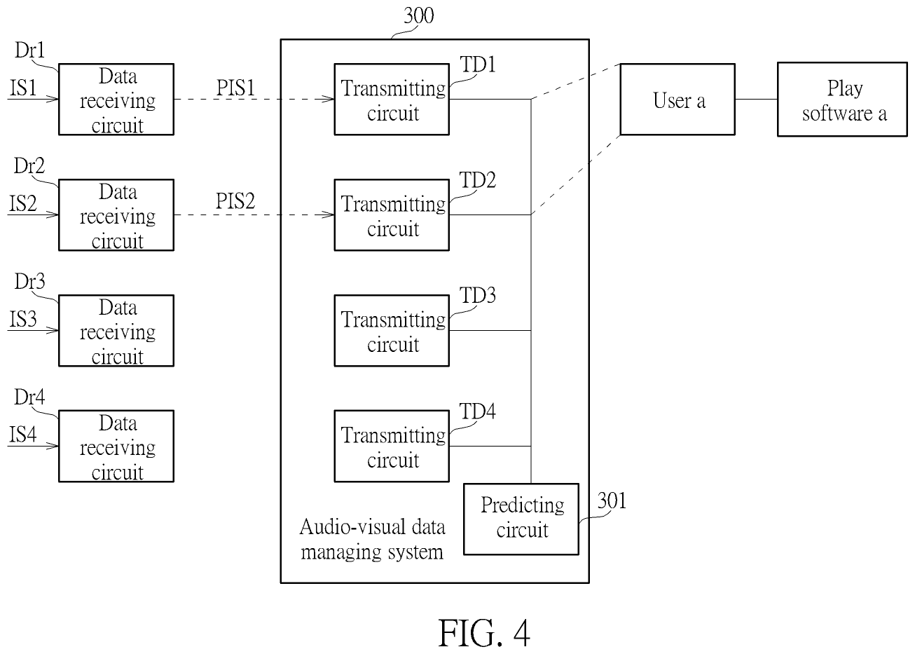

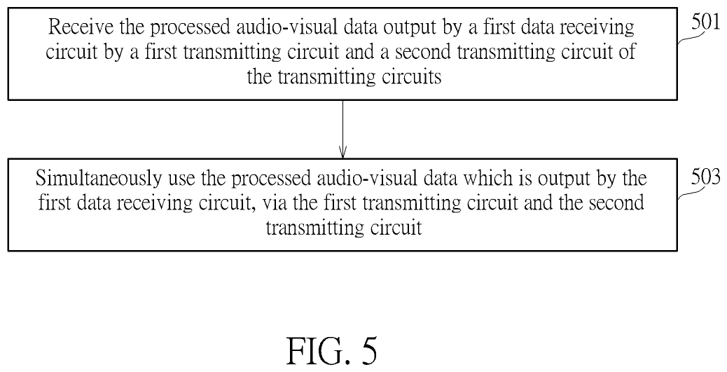

According to the above-mentioned embodiments, an audio-visual data managing method can be obtained. FIG. 5 is a flow chart illustrating an audio-visual data managing method according to one embodiment of the present invention, which is used in at least one data receiving circuit. The method in FIG. 5 corresponds to the embodiments in FIGS. 1 and 2 and comprises the following steps:

Step 501

Receive the processed audio-visual data output by a first data receiving circuit (For example, the processed audio-visual data output by the data receiving circuit Dr1 in FIG. 1) by a first transmitting circuit (such as the transmitting circuit TD1 in FIG. 1) and a second transmitting circuit of the transmitting circuits (such as the transmitting circuit TD4 in FIG. 1).

Step 503

Simultaneously use the processed audio-visual data which is output by the first data receiving circuit, via the first transmitting circuit and the second transmitting circuit.

The audio-visual data managing method shown in FIG. 5 may also use the embodiments shown in FIG. 3 and FIG. 4 in combination. In this case, the following steps may be further comprised: pre-connecting a third transmitting circuit of the transmitting circuits (such as the transmitting circuit TD2 in FIG. 3) and one of the data receiving circuits (such as the data receiving circuit Dr1 or Dr2 in FIG. 3) according to the recorded predicting information.

Other detail steps are disclosed in the foregoing embodiments, thus are omitted for brevity here. Please also note that the scope of the present invention is not limited to the number and configurations of the data receiving circuits and transmitting circuits in the foregoing embodiments.

According to the above-mentioned embodiments, different transmitting circuits can share the same data receiving circuit, and the play software does not take exclusive control of the hardware. Further, with the predicting mechanism, users can quickly switch between different TV channels or different data sources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio-visual managing system, applied to at least one data receiving circuit which receives audio-visual data and outputs processed audio-visual data, each of the data receiving circuit comprising a tuner or a demodulator, the audio-visual managing system comprising:
a plurality of transmitting circuits, configured to stream the processed audio-visual data;
wherein the processed audio-visual data output by a first data receiving circuit of the data receiving circuit can be used by a first transmitting circuit and a second transmitting circuit of the transmitting circuits simultaneously, when the first transmitting circuit and the second transmitting circuit receive the processed audio-visual data output by the first data receiving circuit.

2. The audio-visual managing system of claim 1, when the first transmitting circuit and the second transmitting circuit receiving the processed audio-visual data output by the first data receiving circuit, different play programs being used to simultaneously play audio-visual data which are generated via the first transmitting circuit and the second transmitting circuit and according to the processed audio-visual data output by the first data receiving circuit.

3. The audio-visual managing system of claim 1, when the first transmitting circuit and the second transmitting circuit receive the processed audio-visual data output by the first data receiving circuit, audio-visual data which is generated via the first transmitting circuit and according to the processed audio-visual data output by the first data receiving circuit being played, and the audio-visual data which is generated via the second transmitting circuit and according to the processed audio-visual data output by the first data receiving circuit being stored.

4. The audio-visual managing system of claim 1, the audio-visual data being cable TV data, Internet Protocol TV data, or a personal video file.

5. An audio-visual managing system, applied to at least one data receiving circuit which receives audio-visual data and outputs processed audio-visual data, each of the data receiving circuit comprising a tuner or a demodulator, the audio-visual managing system comprising:
a plurality of transmitting circuits, configured to stream the processed audio-visual data, a first transmitting circuit of the transmitting circuits receiving the processed audio-visual data output by a first data receiving circuit of the data receiving circuits; and
an predicting circuit, configured to pre-connect a second transmitting circuit of the transmitting circuits to one of the data receiving circuits according to predicting information which is recorded.

6. The audio-visual managing system of claim 5, the audio-visual data being cable TV data, Internet Protocol TV data, or a personal video file.

7. The audio-visual managing system of claim 5, the predicting circuit pre-connecting the second transmitting circuit to the first data receiving circuit according to the predicting information.

8. The audio-visual managing system of claim 5, wherein the predicting circuit pre-connects the second transmitting circuit to a second data receiving circuit of the data receiving circuits according to the predicting information.

9. The audio-visual managing system of claim 5, the predicting information comprising time information of different audio-visual data watched in a predetermine time, the predicting circuit pre-connecting the second transmitting circuit to one of the data receiving circuits according to the time information.

10. The audio-visual managing system of claim 5, the predicting information comprising a corresponding relation between users and watched frequencies of different audio-visual data, the predicting circuit pre-connecting the second transmitting circuit to one of the data receiving circuits according to the corresponding relation.

11. An audio-visual managing method, applied to at least one data receiving circuit which receives audio-visual data and outputs processed audio-visual data, each of the data receiving circuit comprising a tuner or a demodulator, the audio-visual managing method comprising:
receiving the processed audio-visual data output by a first data receiving circuit by a first transmitting circuit and a second transmitting circuit of the transmitting circuits; and
simultaneously using the processed audio-visual data which is output by the first data receiving circuit, via the first transmitting circuit and the second transmitting circuit.

12. The audio-visual managing method of claim 11, further comprising:
using different play programs to simultaneously play audio-visual data, which are generated via the first transmitting circuit and the second transmitting circuit and according to the processed audio-visual data output by the first data receiving circuit.

13. The audio-visual managing method of claim 11, further comprising:
playing audio-visual data which is generated via the first transmitting circuit and according to the processed audio-visual data output by the first data receiving circuit, and storing audio-visual data which is generated via the second transmitting circuit and according to the processed audio-visual data output by the first data receiving circuit.

14. The audio-visual managing method of claim 11, the audio-visual data being cable TV data, Internet Protocol TV data, or a personal video file.

15. The audio-visual managing method of claim 11, further comprising:
pre-connecting a third transmitting circuit to the first data receiving circuit according to predicting information which is recorded.

16. The audio-visual managing method of claim 15, further comprising:
pre-connecting the third transmitting circuit to the first data receiving circuit according to the predicting information.

17. The audio-visual managing method of claim 15, further comprising:
pre-connecting the third transmitting circuit to a second data receiving circuit of the data receiving circuits according to the predicting information.

18. The audio-visual managing method of claim 15, the predicting information comprising time information of different audio-visual data watched in a predetermine time.

19. The audio-visual managing method of claim 15, the predicting information comprising a corresponding relation between users and watched frequencies of different audio-visual data.
